(19) United States
(12) Patent Application Publication
(10) Pub. No.: US 2015/0242781 A1
(43) Pub. Date: Aug. 27, 2015

(54) Employee Scheduling Methods Utilizing Enhanced Manpower Forecasting

(71) Applicant: Workuments, LLC, Annapolis Junction, MD (US)

(72) Inventors: Joseph Mancuso, Dallas, TX (US); Dmitriy Matthew Shlosberg, Sykesville, MD (US)

(73) Assignee: WORKUMENTS, LLC, Annapolis Junction, MD (US)

(21) Appl. No.: 14/191,858

(22) Filed: Feb. 27, 2014

(51) Int. Cl. G06Q 10/06

(52) U.S. Cl. CPC G06Q 10/06312

(57) ABSTRACT

An improved method for providing the service of assisting a service user to forecast their workforce staffing needs, when their workloads can be impacted by upcoming special events occurring in their geographic vicinity, includes: (a) collecting and storing advance information for such upcoming special events, and (b) utilizing this advance information to alert a service user of those upcoming special event that are likely to impact the service user's workforce staffing needs, (c) collecting and storing the service user's historical data pertaining to the workforces utilized for various work shifts, (d) collecting and storing the historical data pertaining to the occurrence of special events during these work shifts, and (e) correlating this special events and workforce staffing data to identify the likely impact of future special events on the workforce staffing needs of the service user.

### BACKGROUND OF THE INVENTION

1. Field of the Invention

The present invention generally relates to data processing methods. Specifically, the invention is directed to employee scheduling methods that are improved by using better manpower forecasting techniques.

2. Description of the Related Art

There are many types of employee scheduling and workforce management systems. See, for example, those disclosed in U.S. Patent Publications 2013/0090968, 8,543,440, 8,401,884, 7,877,285, 6,587,831 and 6,049,776.

Most of these typically include a basic planning capability to enable a manager to forecast future workloads and select the employee headcount requirements to service such workloads. Most of these also provide a scheduling capability which allocates employee work hours according to forecasted staffing requirements. Employees are assigned to fill the schedules and employee assignments are posted.

The conventional manpower forecasting techniques of these systems are generally computationally-efficient, accurate on a macro scale, and to a limited degree, able to accommodate real-time changes in workload volumes. However, such manpower forecasting techniques generally place a large percentage of their emphasis on using a firm's historic employee scheduling data to help prepare future employee work schedules.

Known workforce management systems usually do not account for the many extrinsic factors that can influence workload demands and manpower forecasting. Among such factors are weather, traffic, and the general business climate. For business entities in restaurant and entertainment industries, this list of workload influencing factors can also include the occurrence of special occasion events that would be expected to draw larger than normal crowds into the geographic regions served by such business entities. As a result, the forecasting provided by such systems is subject to workforce shortages and over-supplies; especially when an extrinsic event influences a region served by a company using such a system.

What is needed in the art is an improved scheduling system and method that dynamically incorporates the expected impact of the extrinsic factors that influence a business entity's workload. The present invention satisfies this and other needs.

### SUMMARY OF THE INVENTION

Recognizing the need for better manpower forecasting techniques and the resulting improved employee scheduling methods, the present invention is generally directed to overcoming the problems and disadvantages exhibited by the prior are in this field.

According to the present invention, a method for providing the service, in an environment of networked computing devices with a service-providing server having a data processor and storage medium, of assisting a service user with the task of forecasting workforce staffing needs when the workload of the service user could be impacted by any one of a plurality of temporarily varying, upcoming special events occurring in the geographic vicinity of the location of the service user, and wherein advance information for the upcoming special events is available on the network, includes the steps of: (a) collecting and storing the advance information for the upcoming special events occurring in the geographic vicinity of the service user, and (b) utilizing the advance information for the upcoming special events to alert, in a timely manner and when it appears that one of the upcoming special events is likely to impact the workforce staffing needs of the service user, the service user of the likely-impacting, upcoming special event.

A first variant of this method also includes: (c) collecting and storing the historical data pertaining to the workforce staffing utilization during the work shifts of the service user and the adequacy of these staffing utilization, (d) collecting and storing the historical data pertaining to the occurrence of special events in the geographic vicinity of the service user during the work shifts of the service user, (e) correlating the workforce staffing utilization during the work shifts of the service user with the historical special events occurring during the work shifts so as to identify the historic impact of the special events on the workforce staffing of the service user, and (f) utilizing the identified historic impacts and the information on the upcoming special events to determine when it appears that one of the upcoming special events is likely to impact the workforce staffing needs of the service user.

A second variant of this method also includes: (g) utilizing the results of the correlating step to forecast a specific quantifiable change needed in the workforce staffing requirements of the service user in response to a defined type of upcoming special event in the geographic vicinity of the service user, and (h) providing the service user with this forecasted specific quantifiable change needed in the workforce staffing requirements of the service user in response to the defined type of upcoming special event in the geographic vicinity of the service user.

A third variant of this method may also include: (i) creating an industry-specific, knowledge database of predictive manpower staffing needs as a result of enabling the service users to share their historical data pertaining to their workforce staffing utilizations so as to create a larger pool of data from which to identify the correlations of the workforce staffing requirements with the occurrence of nearby special events.

Thus, there has been summarized above (rather broadly and understanding that there are other preferred embodiments which have not been summarized above) is the present invention in order that the detailed description that follows may be better understood and appreciated.

### BRIEF DESCRIPTION OF THE DRAWINGS

FIG. 1 is a block diagram illustrating the general architecture of a system of the claimed invention.

FIG. 2 presents an example of a possible website screen shot created by the present invention of an “employee scheduling screen” that a service user would use to schedule a business' workforce for a time period or work shift when a nearby concert is to occur.

FIG. 3 presents an example of a possible website screen shot created by the present invention of an “employee scheduling screen” that a service user would use to schedule a business' workforce for a time period or work shift when both an evening concert and an earlier in the day, cultural event are occurring.

FIG. 4 is a block diagram that generally illustrates the method of the present invention.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention generally relates to employee scheduling methods and systems that are improved upon by using better and more accurate, manpower forecasting techniques. Businesses that experience significant variations in their daily workloads and the number of hourly workers utilized to pursue these workloads usually use some type of scheduling software in order to schedule when their hourly employees are to come to work, etc. Examples of the types of businesses or industries that might use such software include those in manufacturing, retail and hospitality, including lodging, restaurants and transportation.

When scheduling employees, managers have to first forecast their business' expected workload during prescribed periods of time or employee work shifts in order to identify as precisely as possible the correct number of hourly employees to schedule for work during a specific, prescribed periods of time or work shift. For example, restaurants managers know that they typically have a higher number of diners or customers on Friday nights and fewer diners on Monday afternoon, and must schedule their workforces accordingly.

However, it often happens that there may be nearby-to-the-restaurant, planned special events which could significantly impact the number of diners that come into a restaurant during a prescribed period of time for which a manger is trying to identify and schedule what the restaurant's employee workforce will be. Examples of such special events could include an entertainment or special purpose event that will draw a larger number of potential customers to the geographic vicinity of the restaurant (e.g., a concert, festival or street fair, a sporting event, a political rally, a special-event ceremony at a nearby school, church or public arena) and a change to roads and/or the normal transportation patterns in the vicinity of the restaurant.

To address these situations and provide for more accurate manpower forecasting and employee scheduling, the present invention provides for and incorporates data feeds from a variety of external sources in order to collect information about these various types of events that can impact a business' workload. Information about these special events is then displayed to the users of the present invention or system as they open up the system's software to schedule a business' employees during the prescribed periods of time when these special events are planned to occur.

For example, a manager can see on the screen shot of a spreadsheet, that the system creates for a manager to use for employee scheduling, an alert about a nearby concert which is planned to occur during the work shift that the manager is trying to schedule the business' workforce. In addition to providing such visual alerts, the is system can also provide the manager with scheduling advice or employee headcount tips based upon what occurred to the business' workload when similar such events occurred in the past.

The system is able to provide such advice because it chronologically stores in its database the occurrence and details (e.g., Billy Joel concert during the hours of 8-10:30 pm that had an attendance of 2, 483 and an average concert ticket price of $22.50 within 1.2 miles of the restaurant) of such special events and the business workload demands of its service users during the work shifts that correspond to or are expected to be impacted by the timing of the special events (e.g., for a 2 workshift restaurant, for the 4 pm to 12 pm shift of the concert event: total receipts of $5,974, 112 meals served at an average price $42.25/meal, 276 beverages served at an average cost of $4.50/beverage).

For example, if a restaurant typically needs ten waiters on a Friday night and, the last time there was a nearby Friday night, evening concert by an entertainer who would be expected to draw a demographically similar audience of 2,000 fans as this event's scheduled entertainer, it served 100 more meals and 250 more beverages than usual, the system will alert one who is using the system's spreadsheet for employee scheduling of the possible need for more than the normal number of waiters when it sees that such a nearby concert is again scheduled. Similarly, if the weather forecast calls for rain and the system knows that the patio was closed the last time it rained, the system will automatically suggest to the manager to close the patio and remove the patio waiter from the schedule.

In a healthcare environment, a hospital may want to schedule workers to work extended shifts during snow because other workers may not be able to make it to the hospital. The present invention warns managers of such events and can automatically alert scheduled employees of the need to possibly work beyond the planned end of their work shifts. Similarly, the system may want to alert a hospital manager to schedule more emergency room staff during a flu outbreak period whose occurrence has been noted and inputted into the system. In a law enforcement environment, police offers may need to be scheduled for additional shifts on planned concert or festival days.

In order to be able to reliably provide such alerts and advice regarding upcoming, potentially-manpower-impacting, special events, the present system has been provided with the capability to search appropriately networked databases and the internet for advance information pertaining to such special events. Additionally, those who would be expected to have such event information are incentivized to network with the present invention and input such information into the system.

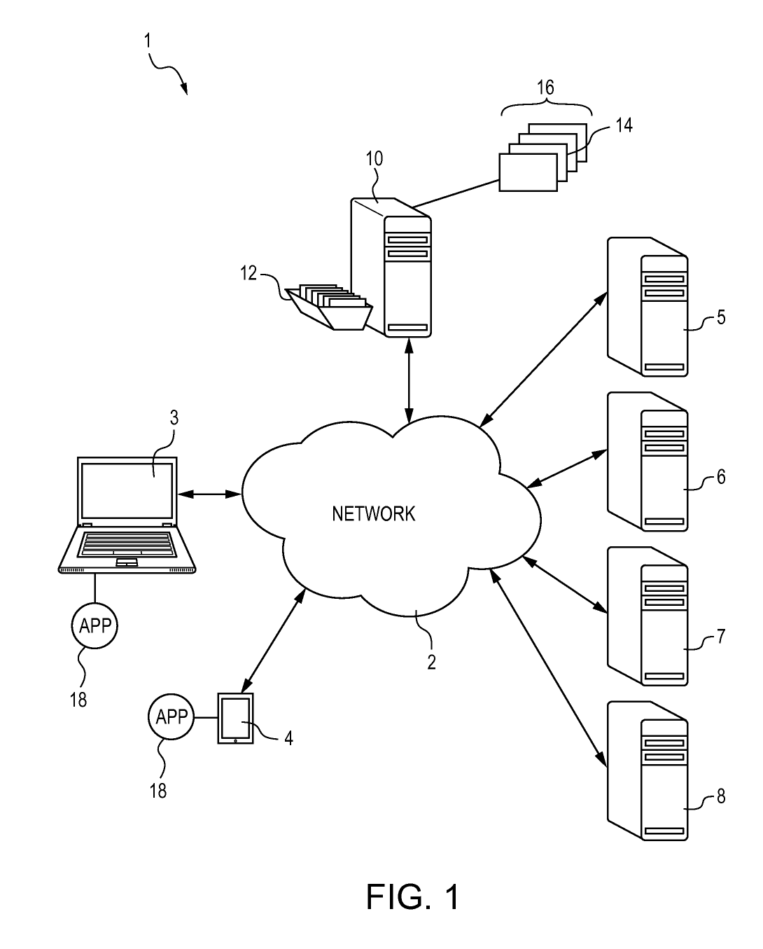

In a preferred embodiment, the present invention is a fully-integrated, cloud-based workforce management software solution that allows small, midsized, and large companies to better predict their manpower demands and optimize employee scheduling. As shown in FIG. 1, the online scheduling system of the present invention 1 is accessed across a distributed network 2, such as the internet, and preferably operates from a host server 10. Communications between users of the system are by way of conventional telecommunications systems and links, i.e., managers and employees can access the host server through possibly specialized or customized interfaces using assigned passwords and either standard, internet-connected, computer processing device such as a laptop 3, desktop PC, smart phone 4, etc. These various input and output mechanisms are utilized so as to make a manager or employee's use of the present invention as user friendly and time efficient as possible.

Also connected to this network are the computing and communication devices, e.g., 5-8, of those entities that possess the advance information regarding the special events which are nearby to the business of a service user and whose occurrence can impact the business' manpower needs for upcoming, prescribed period of time. This advance information is harvested by the present invention and stored in portions of the system's databases 12.

The services of the present invention are provided by utilizing various webpages 14 or documents/spreadsheets 16 that are created by the present invention for use by service users on its cloud-based service platform, or the special software applications 18 of the present invention that may be needed to run on the various computing devices (e.g., smart phones) that are used by the present invention in providing its services.

The control software that runs on the server that is used to provide the present invention is configured such that it allows a service user to provide all the background and employee information necessary to allow a spreadsheet which provides a manager with the various employee options that the manager has for scheduling the necessary workforce for a prescribed period of time or work shift. The software of the present invention will, using the information in its business and employee database, automatically lay out the employee scheduling options for a manager.

The software of the present invention is further configured to be a total workforce management tool. It consequently has employee: (a) background, (b) performance management, (c) time-attendance and (d) recruitment-onboarding modules that supplement its manpower forecasting and employee scheduling functions.

Its employee background module allows a business or service user to store all employee records, including contact information, demographics, emergency contacts, web presence, availability and time off requests, past education, past employment, licenses and certifications with expiration alerts, background checks, current job info as job history with current employer, current compensation and compensation history with current employer, succession variables, job location information, time off balances and adjustments, company benefits selections, general notes, documents, forms, and other (custom) variables.

Its performance management module allows a company to track employee skills, training records, employee accomplishments, awards, kudos, manage performance evaluations and all associated forms to document these aspects of the management of its employees.

Its time-attendance module allows a company to accurately monitor and record its employees' time on the job and to document it in numerous formats, including EEOC and various compliance reports. Highly customizable digital timesheets are provided for these monitoring tasks, as well as punch clocks with employee fingerprint recognition capabilities.

Finally, its recruitment-onboarding module allows a company to manage all aspects of the company's strategic workforce planning, recruitment and hiring and related processes, including the various aspects related to the orientation of a new employee.

For its manpower forecasting and employee scheduling functions, the software of the present invention is configured to implement algorithms that search the system's database for information regarding past, nearby-to-the business special events that are similar to an upcoming special event so as to lookup a business' manpower staffing for the prior event and any comments that may be in the database as to whether this level of staffing was adequate. Eventually a lookup table is prepared for each type of business or service user that documents the percentage impact on the workload for each type of special event as a function of the parameters of the special event (e.g., event is of the type that is expected to draw a crowd of 2,000 whose ages are predicted to be percentage distributed as follows: e.g., 10-20: 20%, 20-40: 50% and over 40: 30%, with the event being 0.5 miles from the business' location and it hours being 7:00-10:00 pm).

Thus, such lookup table can be used to predict that a restaurant that normally employs two cooks and a wait staff of ten at a planned capacity percentage of 70% would be advised to schedule an additional cook and 4-5 waiters when its lookup table for a similar prior event predicts a 50% increase in the number of diners seeking service before and after such an event. Since there are in the literature many suitable forms of algorithms which are available for one to utilize to make these searches and organize these lookup tables, such algorithms will not be discussed in any detail herein.

It can be noted that the manpower predictive capabilities of the present invention for a particular type of business in response to various types of nearby, upcoming special events is limited by the extent of the business' historical database of the actual staffing used during prior such special events and the business' assessment of the adequacy of such staffing. Thus, it could often occur that when such data is not available, the ability of the present invention to adequately predict such manpower needs could be quite limited.

However, the present invention resolves this problem by enabling its service users to anonymously share their manpower data and its correlation to nearby special events so as to create a first-ever, industry specific knowledge database of predicted manpower staffing needs for different types of businesses in response to the occurrence of nearby special events. The advantage to all those service users who agree to share such data is that they get access to a much larger database of information that therefore has much greater predictive capabilities—thus, everyone wins by sharing such data. For those businesses that have a lengthy period of manpower staffing data and think that their historical manpower data can be correlated with historical special event data to yield sufficiently accurate manpower prediction algorithms or lookup tables, such businesses or service user may elect not to share their historical manpower data.

Thus, it may be the case that, for example, a thousand restaurants located in two hundred cities are service users who may agree to share their historical manpower data. In some cases this data may be for a restaurant in city X that only has seating for 40 diners and only goes back for the 6 months of the restaurant's existence. In other cases, this historic manpower data could be for a restaurant in city Y that seats 250 and extends over a period of 10 or more years. By pooling this data and correlating it with nearby special events (e.g., concerts, sporting event, road closures, weather conditions) and the parameters which characterize these special events (e.g., concert attended by 2,000 with an age demographic of <20: 20%, 20-40: 70% and >40: 10% and located within 0.5 miles of the restaurant) and then expressing any actual manpower staffing differences resulting from these special events as percentage changes, one finds that a much more robust and predictively accurate knowledge database can be developed.

The present invention is ideally configured in such a manner as to build on and complement electronic event scheduling databases, both today and into the future. Because of this commitment, its preferred embodiment is configured to run on a “cloud” server platform for maximum portability. The present invention requires that minimal local software be downloaded or installed. This approach simplifies the usually involved software application (app) certification process. The interface of the present invention is simply a website which its users visit. Local software and interfaces are only used to enable access to local technology on the user device.

All user interfaces of the present invention, as currently configured, are preferably HTML5 browser based. The software of the present invention is configured so as to perform on Windows and Apple desktops using current browsers. Smartphone and tablet compatibility is also provided—Apple iOS, Android, and Windows 8 are fully supported.

The software of the present invention is configured so that its mobile interface operates with the look and feel of a local application, i.e., launched from an icon without starting the browser, even though it will run through the browser.

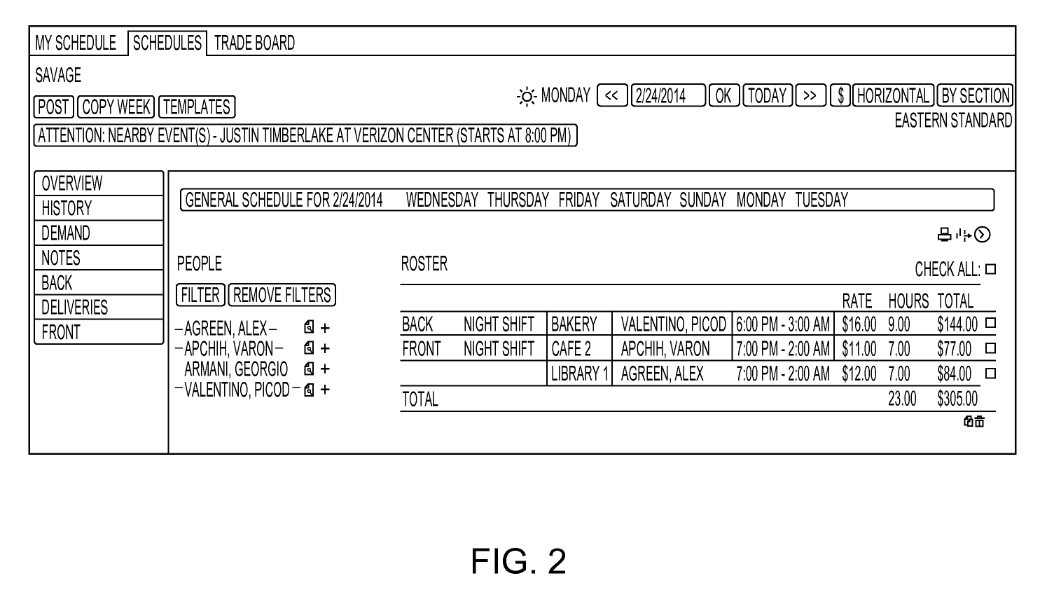

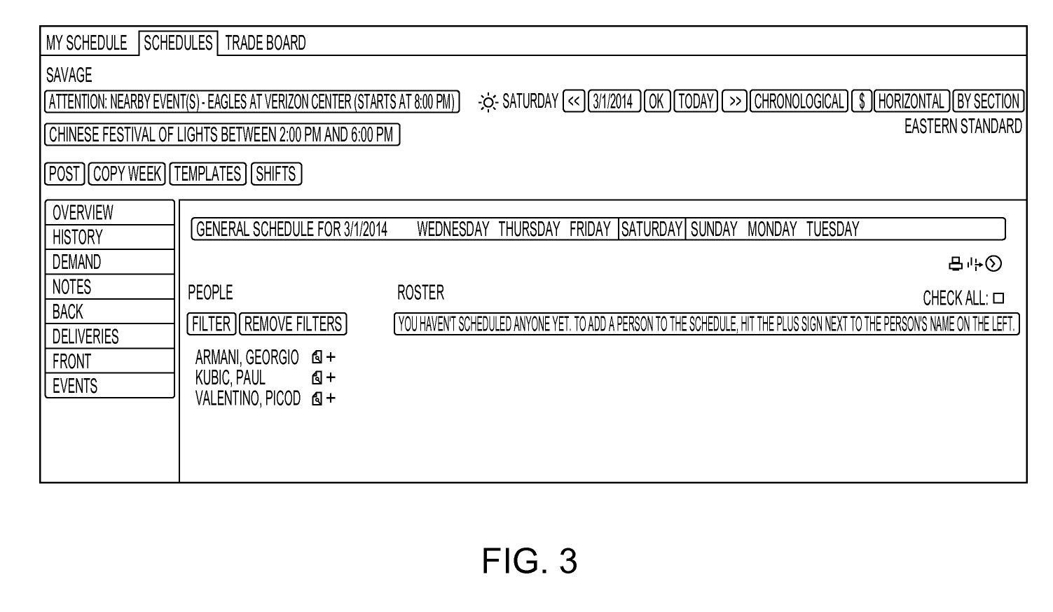

To better acquaint one with the software requirements and capabilities of the present invention, shown in this application's FIGS. 2-3 are various user interface screen illustrations. They could be in a webpage or smart phone or tablet format, but are shown here in a webpage format.

FIG. 2 shows an example of a possible “employee scheduling screen” for the present invention where a manager needs to schedule a business' workforce for a time period or work shift when a nearby concert is to occur. In this instance the present invention has provided an alert on the manager's scheduling webpage or worksheet that makes the manager aware of this planned concert. Depending on the amount of prior event information in this or a related business' database, a suggestion for a percentage workforce change will also be provided with this alert. FIG. 3 shows a similar example of a possible “employee scheduling screen” when two nearby event are occurring—both an evening concert and an earlier in the day cultural event.

The above-described steps of the present can be implemented using standard well-known programming techniques. The novelty of the above-described embodiment lies not in the specific programming techniques but in the use of the steps described to achieve the described results. Examples of such steps that are applicable to the present invention include:

(a) collecting and storing the historical data pertaining to the workforce staffing utilization during the work shifts of a service user and the adequacy of these staffing utilization—typically a service user would input this information directly into is the system, the benefit to the service user of inputting this needed information being that it would, in return, receive the system's predictions for specific, recommended, work shift manpower increases/decreases due to upcoming nearby special events before the service user had to schedule their workforce during the time periods that are likely to be impacted by the special events,

(b) collecting and storing the historical data pertaining to the workloads that a service user experienced during their various work shifts—again, with such data being inputted by a service user,

(c) collecting and storing the historical data pertaining to the occurrence of special events in the geographic vicinity of the service user during the work shifts of the service user—this information is inputted by a network of special event organizers, news outlets or data collection resources which are incentivized to go online and share this information with the system; this information can also be collected by search engines utilized by the present invention that mine the internet for the advance information for such special events,

(d) correlating the workforce staffing utilization during the work shifts of the service user with the historical special events occurring during the work shifts so as to identify the historic impact of the special events on the workforce staffing of the service user,

(e) collecting and storing the advance information for upcoming special events occurring in the geographic vicinity of the service user—again, this information is inputted by participating special event organizers, news outlets or data collection resources, etc.,

(f) utilizing the identified historic impacts and information on the upcoming special events to alert the service user to a possible change needed in the manpower forecast applicable to the time period of an upcoming special event that is to occur in the vicinity of the service user—see FIGS. 2-3 for examples of such alerts,

(g) utilizing the results of the correlating step to forecast a specific quantifiable change needed in the workforce staffing requirements of the service user in response to a defined type of upcoming special event in the geographic vicinity of the service user,

(h) providing the service user with this forecasted specific quantifiable change needed in the workforce staffing requirements of the service user in response to the defined type of upcoming special event in the geographic vicinity of the service user, and

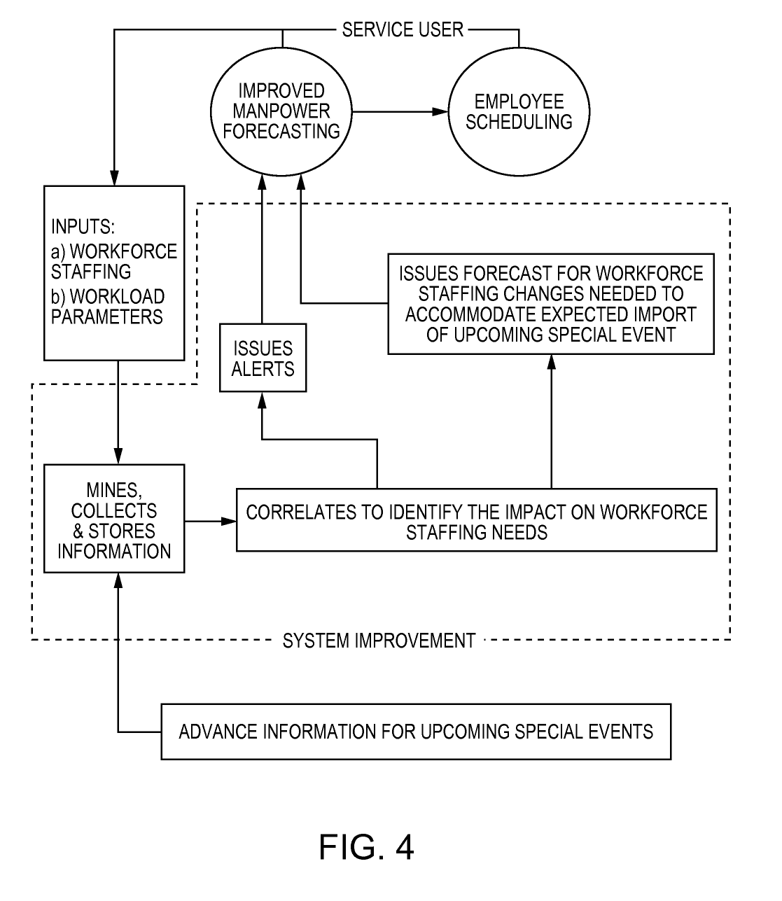

(i) creating an industry-specific, knowledge database of predictive manpower staffing needs as a result of enabling the service users to share their historical data pertaining to their workforce staffing utilizations so as to create a larger pool of data from which to identify the correlations of the workforce staffing requirements with the occurrence of nearby special events; see FIG. 4.

Software programming code that embodies the present invention is typically stored in permanent storage. In a client/server environment, such software programming code may be stored with storage associated with a server. The code of the present invention may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each above-listed elements or steps or a combination of them can be implemented by general and/or special purpose hardware-based systems that perform the specified functions or steps, or by combinations of general and/or special-purpose hardware and computer instructions. These program instructions may be provided to a processor to produce a machine or apparatus, such that the instructions that execute on the processor create means for implementing the functions and steps specified in this application.

The foregoing is considered as illustrative only of the principles of the present invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention that are hereinafter set forth in the claims to the invention.

1. A method, performed by a service-providing server, having a processor and a storage medium, that is connected to a network of computing devices, of providing the service to a plurality of service users, each of which has a computing device connected to said network, of assisting each of said service users with the task of forecasting the workforce staffing needs of each of said service users when the workload of said service users could be impacted by any one of a plurality of temporarily varying, but scheduled, upcoming special events occurring in the geographic vicinity of the location of said service users, and wherein advance information for said scheduled, upcoming special events is available on said network, said method comprising the steps of:
enabling said service-providing server to perform the function of collecting and storing, in an upcoming special events database on said storage medium of said service-providing server, said advance information for said scheduled, upcoming special events occurring in the geographic vicinity of each of said plurality of networked service users,
enabling said service-providing server to utilize said advance information for said scheduled, upcoming special events to perform the function of alerting, in a timely manner and when it appears that one of said scheduled, upcoming special events is likely to impact the workforce staffing needs of one of said plurality of service users, the one of said plurality of service users likely to be impacted by said scheduled, upcoming special event,
collecting and storing, in a staffing database on said storage medium of said service-providing server, the historical data pertaining to the workforce staffing utilization during the work shifts of each of said service users and the adequacy of said workforce staffing utilization,
collecting and storing, in a special event database on said storage medium of said service-providing server, the historical data pertaining to the occurrence of scheduled, special events in the geographic vicinity of each of said service users during said work shifts of said service users for which there has been collected and stored said historical data pertaining to workforce staffing utilization,
correlating said workforce staffing utilization during said work shifts of each of said service users with said historical scheduled, special events occurring during said work shifts so as to identify the historical impact of said scheduled special events on the workforce shift staffing of each of said service users, and
utilizing said identified historical impacts and said information on said upcoming, scheduled, special events to determine when it appears that one of said upcoming, scheduled, special events is likely to impact the workforce staffing needs during a work shift of one of said service users.

2. (canceled)

3. The method recited in claim 1, further comprising the steps of:
utilizing said results of said correlating step to forecast a specific quantifiable change needed in the workforce staffing requirements of said service user in response to a defined type of upcoming scheduled, special event in the geographic vicinity of said service user, and
providing said service user with said forecasted specific quantifiable change needed in the workforce staffing requirements of said service user in response to said defined type of upcoming scheduled, special event in the geographic vicinity of said service user.

4. (canceled)

5. The method recited in claim 3, further comprising the step of:
creating an industry specific knowledge database of predictive manpower staffing needs as a result of enabling said service users to share said historical data pertaining to the workforce staffing utilizations of said service users so as to create a larger pool of data from which to identify said correlations of said workforce staffing requirements with said nearby scheduled, special events.

6. (canceled)

7. The method recited in claim 3, wherein:
said scheduled, special event chosen from the group including a nearby entertainment or special purpose event that will draw a larger number of potential customers to the geographic vicinity of said service user, and a transportation system change that will vary the normal transportation patterns in the vicinity of the service user.

8. (canceled)

9. The method recited in claim 5, wherein:
said scheduled, special event chosen from the group including a nearby entertainment or special purpose event that will draw a larger number of potential customers to the geographic vicinity of said service user, and a transportation system change that will vary the normal transportation patterns in the vicinity of the service user.

10. A system for providing the service, on a network of computing devices, to a plurality service users, each of which has a computer device connected to said network, of assisting each of said a service users with the task of forecasting the workforce staffing needs of each of said service users when the workload of said service users could be impacted by any one of a plurality of temporarily varying, but scheduled, upcoming special events occurring in the geographic vicinity of the location of said service users, and wherein advance information for said scheduled, upcoming special events is available on said network, said system comprising:
a service-providing server, having a data processor and storage medium, and that is connected to said network,
a collection, stored in an upcoming special events database on said storage medium of said service-providing server, of said advance information for said scheduled, upcoming special events occurring in the geographic vicinity of each of said plurality of service users, and
an alert, yielded in a timely manner by utilizing said advance information for said scheduled, upcoming special events and when it appears that one of said scheduled, upcoming special events is likely to impact the workforce staffing needs of one of said service users, to the one of said plurality of service users likely to be impacted by said scheduled, upcoming special event,
a collection, stored in a staffing database created on said storage medium of said service-providing server, of the historical data pertaining to the workforce staffing utilization during the work shifts of each of said service users and the adequacy of said workforce staffing utilization,
a collection, stored in a special event database created on said storage medium of said service-providing server, of the historical data pertaining to the occurrence of scheduled, special events in the geographic vicinity of each of said service users during said work shifts of said service user for which there has been collected and stored said historical data pertaining to workforce staffing utilization,
a correlation of said workforce staffing utilization during said work shifts of each of said service users with said historical scheduled, special events occurring during said work shifts that identifies the impact of said scheduled, special events on the workforce staffing of each of said service users, and
a determination, yielded by utilizing said correlation, of when it appears that one of said upcoming scheduled, special events is likely to impact the workforce staffing needs during a work shift of one of said service users.

11. (canceled)

12. The system as recited in claim 10, said system further comprising:
a forecast, yielded by utilizing said correlation, of a specific quantifiable change needed in the workforce staffing requirements of said service user in response to a defined type of upcoming scheduled, special event in the geographic vicinity of said service user.

13. (canceled)

14. The system as recited in claim 12, said system further comprising:
an industry specific knowledge database of predictive manpower staffing needs created as a result of enabling said service users to share said historical data pertaining to the workforce staffing utilizations of said service users so as to create a larger pool of data from which to identify said correlations of said workforce staffing requirements with said nearby scheduled, special events.

15. (canceled)

16. The system as recited in claim 12, said system further comprising:
said scheduled, special event chosen from the group including a nearby entertainment or special purpose event that will draw a larger number of potential customers to the geographic vicinity of said service user, and a transportation system change that will vary the normal transportation patterns in the vicinity of the service user.

17. (canceled)

18. The system as recited in claim 14, said system further comprising:
said scheduled, special event chosen from the group including a nearby entertainment or special purpose event that will draw a larger number of potential customers to the geographic vicinity of said service user, and a transportation system change that will vary the normal transportation patterns in the vicinity of the service user.

19. A computer program product for use in conjunction with a service-providing server, including a processor and a memory storage device and that is connected to a network of computing devices, the computer program product comprising a computer readable, non-transitory, storage medium and instructions thereon for providing the service to a plurality of service users, each of which has a computing device connected to said network, of assisting a each of said service users with the task of forecasting the workforce staffing needs of each of said service users when the workload of each of said service users could be impacted by any one of a plurality of temporarily varying, but scheduled, upcoming special events occurring in the geographic vicinity of the location of said service users, and wherein advance information for said scheduled, upcoming special events is available on said network, said instructions comprising the steps of:
collecting and storing, in an upcoming special events database on said storage medium of said service-providing server, said advance information for said scheduled, upcoming special events occurring in the geographic vicinity of each of said plurality of networked, service users,
utilizing said advance information for said scheduled, upcoming special events and the connection of said service-providing server to said network to alert, in a timely manner and when it appears that one of said scheduled, upcoming special events is likely to impact the workforce staffing needs of one of said plurality of service users, the one of said service users likely to be impacted by said scheduled, upcoming special event,
collecting and storing, in a staffing database on said storage medium of said service-providing server, the historical data pertaining to the workforce staffing utilization during the work shifts of each of said service users and the adequacy of said workforce staffing utilization,
collecting and storing, in a special event database on said storage medium of said service-providing server, the historical data pertaining to the occurrence of scheduled, special events in the geographic vicinity of each of said service users during said work shifts of said service users for which there has been collected and stored said historical data pertaining to workforce staffing utilization,
correlating said workforce staffing utilization during said work shifts of each of said service users with said historical scheduled, special events occurring during said work shifts so as to create correlations that identify the impact of said scheduled, special events on the workforce staffing of each of said service users, and
utilizing said correlations to determine when it appears that one of said upcoming scheduled, special events is likely to impact the workforce staffing needs during a work shift of one of said service users.

20. (canceled)
